(19) United States
(12) Patent Application Publication
(10) Pub. No.: US 2009/0199360 A1
(43) Pub. Date: Aug. 13, 2009

(54) Cart Handle Dispenser

(76) Inventor: Azmie K. Madanat, Moraga, CA (US)

Correspondence Address: RAY K. SHAHANI, ESQ., ATTORNEY AT LAW, TWIN OAKS OFFICE PLAZA, 477 NORTH NINTH AVENUE, SUITE 112, SAN MATEO, CA, 94402-1858, US

(21) Appl. No.: 12/027,943

(22) Filed: Feb. 7, 2008

(51) Int. Cl. B62B 5/06; B65H 1/00; B25G 1/00

(52) U.S. Cl. 16/111.1; 221/33; 221/1

(57) ABSTRACT

A cart handle with an integral wipe dispenser for storing and dispensing sanitary wipes which consists of a hollow cylindrical canister portion with two ends and an operatively-sized main chamber, two coupling end portions one each attached to each of the two ends of the canister portion, a lid portion hingedly coupled to the main chamber and having an operatively sized and positioned opening, whereby individual sanitary wipes can be dispensed and used for sanitizing the cart handle.

### FIELD OF THE INVENTION

This invention relates to a dispenser device for use on a cart such as a shopping cart, and more particularly, to a rigid and hollow adapter attached to and integral with the handle of carts for the purpose of storing and dispensing sanitary wipes.

### BACKGROUND OF THE INVENTION

Shopping carts are common in most retail outlets. Due to various reasons including storage method and locations, infrequent cleaning, poor maintenance, contamination from goods carried especially at grocery stores where raw produce is sold, shopping carts have long been considered a medium for spreading germs and diseases.

Lately, growing focus has been placed on improving the sanitary level of the handle of shopping carts since users must contact the handles while pushing the carts. U.S. Pat. No. 6,869,085 issued Mar. 22, 2005 to Pettigrew et al., U.S. Pat. No. 7,163,211 issued to Alvarez, U.S. Pat. No. D521,207 issued May 16, 2006, U.S. Pat. No. 5,427,392 issued Jun. 27, 1995 to Duer and numerous other patents all teach some forms of protective sheath or cover for cart handles. These protective covers can come in layers so users can peel the outer layer off and push the cart by holding onto the newly exposed (sanitary) cover. Additionally, shoppers can bring their own protective covers to the stores.

The multi-layered protective cover still requires users to touch and contact the used, and hence contaminated, protective cover while removing it. Moreover, due to heavy traffic in most stores and the limited quantity of protective covers which can be installed, layered protective covers impose logistic problems in maintenance and replenishment.

Moreover, most shoppers have sanitary concerns beyond cart handles, especially shoppers who put their babies and toddlers in the basket portion of carts. Their babies and toddlers may touch any part of the entire shopping carts and contract germs and contaminants. Or they may chew or suck on the cart handle. According to a study conducted by the Environmental Research Laboratory of University of Arizona, grocery carts are havens for traces of human waste, mucus and saliva. Shopping carts have ranked high on the list for worst public items to touch. This is probably due to the fact that most shopping carts are used by many different people and that the seat where babies or other personal items rest with one customer may be used for fruit, raw meat and other products by another. According to an article in the Health section of MSNBC.com dated Oct. 23, 2007, shopping carts rank No. 5 of 12 germiest places in your life. It states that saliva, bacteria and fecal matter are just a few of the substances found on shopping cart handles. Steps to promote more sanitary, less germ filled shopping carts are being promoted in New Jersey and Arkansas, where recent bills have been passed requiring sanitary wipes to be given to customers.

### ADVANTAGES AND SUMMARY OF THE INVENTION

The present invention is a device and method to enhance sanitation of hand and shopping carts with minimum logistic efforts. The system consists of a rigid and hollow adapter attached to and integral with the handle of carts to store and dispense sanitary wipes.

One object and advantage of the present invention is to provide a device with versatility and flexibility to be installed on any type of hand or shopping cart.

Another object and advantage of the present invention is to provide the capacity to store a sufficient number of sanitary wipes to minimize stress imposed on maintenance and replenishment. Store or other management can easily switch and refill stock of sanitary wipes from supply.

Yet another object of the present invention is to allow shoppers to wipe down any part of carts to satisfy their own sanitary standards and concerns.

The present invention is a rigid tube-like adapter with a hollow interior which attaches to any cart handle. Once affixed, the device is permanently or detachably attached to the cart. The present invention includes a disposable container or canister filled with sanitary wipes. An opening slot in the tube adapter allows users to extract one or more wipes from the internal canister. These wipes are designed to be used to clean the surfaces and points of contact with the cart and are safe enough to clean hands and faces. The primary purpose is to diminish the numerous bacteria and viruses which are known to cause diseases which have also been documented in various studies to be associated with hand carts and shopping carts.

As used herein, the term “disinfect” and “sanitize” shall equally and interchangeably mean the elimination of many or all harmful, pathogenic or otherwise medically undesirable bacteria, viruses, mold, or any other microorganisms on the surface of any product, as well as the reduction of any of said undesirable bacteria, viruses, mold, or any other microorganisms or other contaminants on the surface of a product to levels considered safe according to local, customary or required municipal health regulation.

The present invention relates to a disinfecting wipe, housing system and disinfecting composition for cleaning and disinfecting surfaces, in which the disinfecting wipe comprises sanitizing composition adsorbed onto an absorbent carrier material. The present invention also relates to a housing system for storing and dispensing a single or multiple number of disinfecting wipes.

The present invention is an adapter to store and dispense sanitary wipes. The adapter consists essentially of a hollow chamber for coupling integrally with the handle of a cart.

The present invention is also a cart handle that consists essentially of an integral wipe dispenser for storing and dispensing sanitary wipes, the cart handle comprising a hollow canister portion having two ends and an operatively-sized main chamber, two coupling end portions one each attached to each of the two ends of the canister portion, a lid portion having an operatively sized and positioned dispenser opening, the lid portion detachably coupled to the canister portion, whereby individual sanitary wipes can be dispensed and used for sanitizing the cart handle.

In one embodiment of the present invention, wherein the canister portion has a cylindrical shape.

In one embodiment of the present invention, wherein the dispenser opening has a predetermined shape selected from the group consisting of rectangle, oval and circle.

The wipe dispenser of the present invention has a total length in the range of approximately 20 cm to 45 cm.

In one embodiment of the present invention, wherein the coupling end portions further comprises a mechanical fastening system such as adhesives for firmly attaching to any cart handle.

In one embodiment of the present invention, wherein the mechanical fastening system is selected from the group consisting of circlips, cable tie and adhesives.

The present invention is also a cart handle having an integral wipe dispenser for storing and dispensing sanitary wipes. The cart handle of the present invention comprises a hollow canister portion having two ends, an operatively-sized main chamber for hosting an internal housing portion and a lid portion having an operatively sized and positioned dispenser opening, the lid portion detachably coupled to the canister portion, an internal housing portion, the internal portion having an operatively sized and positioned aperture, whereby individual sanitary wipes can pass through and two coupling end portions one each attached to each of the two ends of the canister portion for coupling the cart handle to a cart, whereby individual sanitary wipes can be dispensed and used for sanitizing the cart handle.

The wipe dispenser of the present invention further comprises a mechanical coupling to keep the internal housing portion in place.

In one embodiment of the present invention, wherein the mechanical coupling is selected from the group consisting of flexible clamps, adhesive material, hook and loop material, screws, nuts and bolts.

The present invention is also a method of storing and dispensing sanitary wipes in a shopping cart which includes the following steps:

Step 1. Obtaining a cart handle having an integral wipe dispenser for storing and dispensing sanitary wipes, the cart handle comprising (1) a hollow canister portion having two ends and an operatively-sized main chamber, (2) two coupling end portions one each attached to each of the two ends of the canister portion, (3) a lid portion having an operatively sized and positioned dispenser opening, the lid portion detachably coupled to the canister portion, whereby individual sanitary wipes can be dispensed and used for sanitizing the cart handle;

Step 2. Selecting sanitary wipes that can fit into the main chamber;

Step 3. Installing the sanitary wipes canister inside the chamber and pulling the outer tip of sanitary wipes through the dispenser opening of the lid portion;

Step 4. Closing and locking the lid portion; and

Step 5. Pulling out desirable amount of sanitary wipes.

Further objects and advantages of the present invention will be come apparent through the following descriptions, and will be included and incorporated herein.

### BRIEF DESCRIPTION OF THE DRAWINGS

FIG. 1 is a representative top side isometric view of an embodiment of the cart handle dispenser 100 of the present invention.

FIG. 2 is a top side exploded view of an embodiment of the cart handle dispenser 100 of the present invention.

FIG. 3 shows a method of use of the cart handle dispenser 100 of the present invention.

FIG. 4 is a top side exploded view of an alternative embodiment of the cart handle dispenser 100′ of the present invention.

FIG. 5 is a representative top side isometric view of an alternative embodiment of the cart handle dispenser 500′.

FIG. 6 shows a method of use of the cart handle dispenser 500′ of the present invention.

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

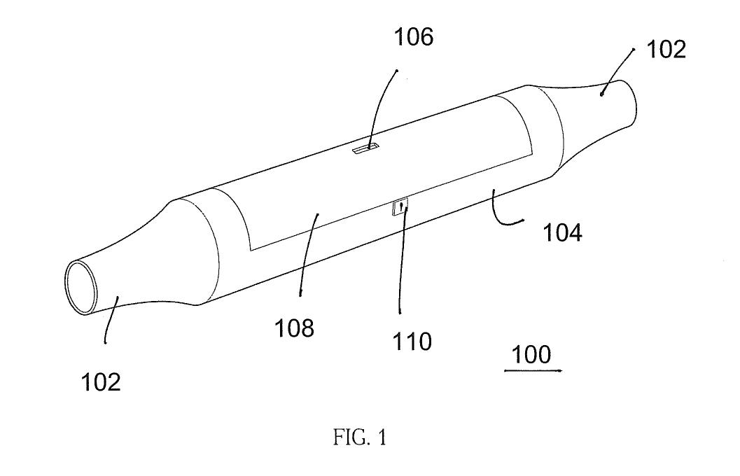

FIG. 1 is a representative top side isometric view of an embodiment of the cart handle dispenser 100 of the present invention. As shown in FIG. 1, in an embodiment, the cart handle dispenser 100 of the present invention is comprising of canister 104 firmly attached to two end portions 102. In one embodiment, canister 104 is a hollow structure in cylindrical shape. End portions 102 have a taper shape with the broader ends firmly attached to the canister 104.

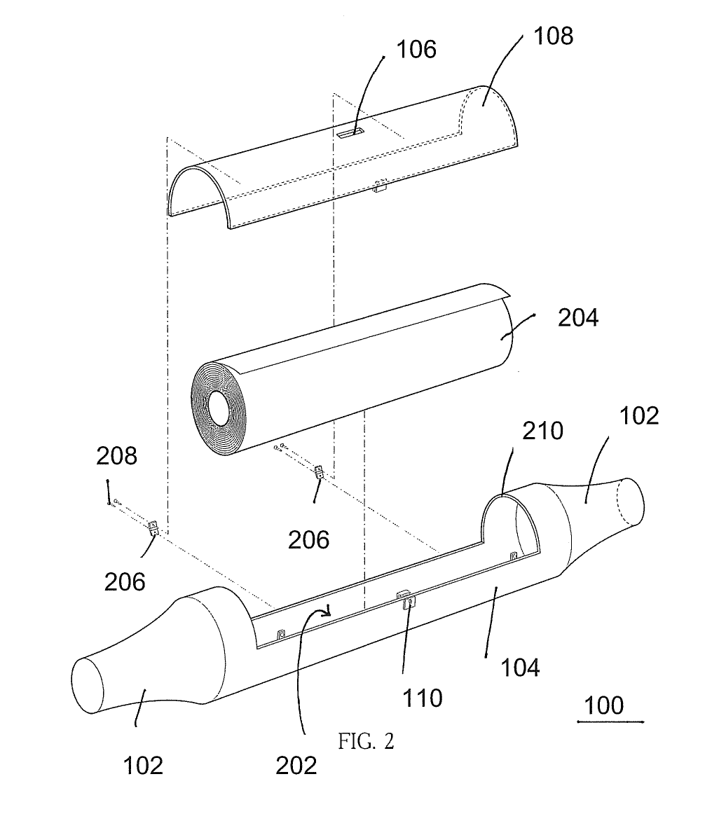

As shown in FIGS. 1 and 2, lid 108 is hingedly attached to canister portion 104 on one edge and by a locking closure 110 on the other edge. In one embodiment, lid 108 is curved in a cylindrical shape and completely seals canister 104 inside an enclosure or chamber area. As shown in FIG. 1, there is a dispenser slot 106 in lid 108. The main function of dispenser slot 106 is to dispense and allow sanitary wipes 204 to be pulled through by users. In one embodiment, lid 108 runs almost the entire length of canister 104 or long enough to allow easy access to the hollow interior 202 of canister 104 during replenishment of sanitary wipes 204. The main function of lid 108 is to seal canister 104 completely to decrease evaporation of cleaning liquid on sanitary wipes 204. It will be understood that lid portion 108 needs only to be sufficiently large to allow replacement of a new roll of wipes 204 as needed.

FIG. 2 is a top side exploded view of an embodiment of the cart handle dispenser 100 of the present invention. As shown in FIG. 2, canister 104 is a hollow structure with a hollow interior chamber 202. The main function of canister 104 is to provide storage for sanitary wipes 204. Sanitary wipes 204 can take the form of a roll, stack, interleaved stack or other designs. In one embodiment, sanitary wipes 204 are confined by the space between the two end portions 102. As shown in FIG. 2, lid 108 is hingedly attached to canister 104 on one edge with a plurality of hinges 200 and screws 208. In one embodiment, the curvature of lid 108 should match the curvature of opening side edges 210 of canister 104 for a well-fitted seal. In one embodiment, lid 108 can be secured to canister 104 by lock 110. The main function of locking canister 104 is to secure and otherwise prevent unwanted theft or tampering with of sanitary wipes 204. As shown in FIG. 2, dispenser slot 106 is a through hole in the shape of a round or circular, rectangular, slotted gripping and sealing rubber diaphragm or other elastomeric and flexible membrane member or other. The area of dispenser slot 106 should be big enough for operative passing of sanitary wipes 204, but not large enough to allow excessive contact with air or other environmental impurities and undesirable materials.

In one embodiment, shop management can pick their choice of sanitary wipes 204 as long as they come in a package that is small enough to fit inside the hollow interior chamber 202 of canister 104. Also, sanitary wipes 204 must be able to continuously dispense prescribed portion of sanitary wipe from the top through slot 106 on the lid 108. In one embodiment, recommended sanitary wipes should contain chemicals strong enough to kill most common germs and bacteria on shopping carts but gentle enough to be used on human skin.

With respect to the chemical composition of the wipes, an essential purpose of the wipes is to provide sanitation of the cart and handle and any other portion of the cart desired, including but not limited to cart interior, baby seats, lower surfaces, etc. It is important to emphasize that these disinfecting and sanitizing agents are anti-bacterial or anti-septic in nature. Typical and customary sanitizing and sterilizing agents which can be used safely and effectively with the present invention include but are not limited to the following categories of chemicals and materials: Alcohols, ethanol, isopropanol, aldehydes including glutaldehyde, halogens including chloramine, chlorine, hypochlorites, iodine, oxidizing agents including chlorine dioxide, hydrogen peroxide, ozone-based chemicals, acid salts, sodium chloride, hypochlorous acid, peracetic acid, potassium permanganate, potassium peroxymonosulfate, phenolics including phenol, phenylphenol, chloroxylenol, hexachlorophene, thymol, quaternary ammonium compounds such as benzalkonium chloride, and other home disinfectants and skin and product sanitizing agents.

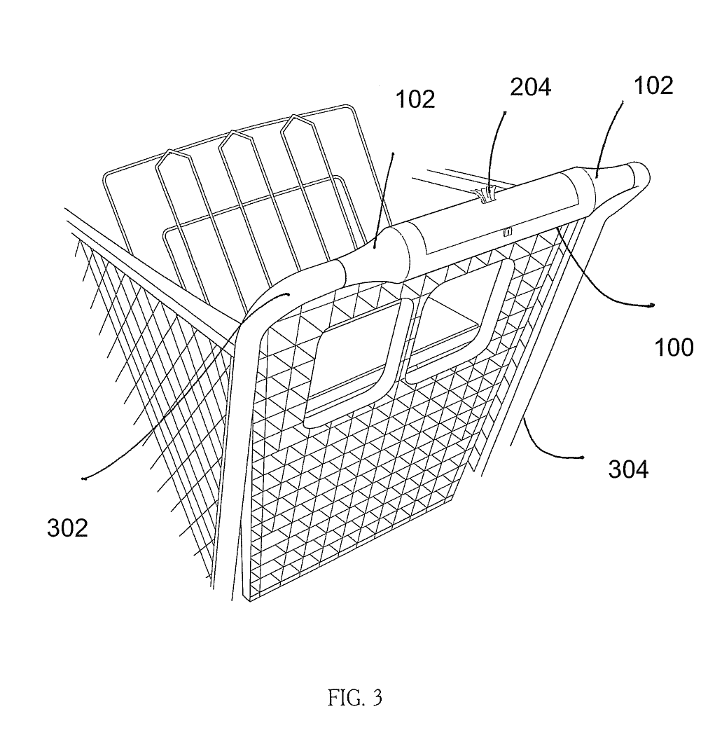

FIG. 3 shows a method of use of the cart handle dispenser 100 of the present invention. As shown in FIG. 3, cart handle dispenser 100 of the present invention is firmly attached to cart handle 302 of cart 304 by means such as screws, adhesive, etc at end portions 102 of cart handle dispenser 100 of the present invention. In one embodiment, after replenishment of sanitary wipes 204, the tip of sanitary swipe 204 should be pulled through slot 106 on lid 108 so users can retrieve an entire swipe 204 by pulling it out of the slot 106. Users can then proceed to wipe down any part of the cart 302 as they desire.

In one embodiment, shop management can pick their choice of sanitary wipes 204 as long as they come in a package that is small enough to fit inside the hollow interior 202 of canister 104. Also, sanitary wipes 204 must be able to continuously dispense prescribed portion of sanitary wipe from the top through slot 106 on the lid 108. In one embodiment, recommended sanitary wipes should be a stable cleaning and disinfecting wipe and article that is capable of cleaning and removing residues from soiled surfaces while simultaneously destroying undesirable microorganisms, e.g. bacteria, mold, viruses, prions and the like that colonize on common surfaces with which people come into contact on shopping carts. In one embodiment, one effective disinfecting and cleaning composition can be but not limited to hypohalite bleach which is an alkali metal and/or alkaline earth metal hypochlorite, or mixtures thereof. More preferably, for liquid compositions said hypohalite bleach is an alkali metal and/or alkaline earth metal hypochlorite selected from the group consisting of sodium hypochlorite, potassium hypochlorite, magnesium hypochlorite, lithium hypochlorite and calcium hypochlorite, and mixtures thereof. Even more preferably, for liquid compositions said hypohalite bleach is sodium hypochlorite.

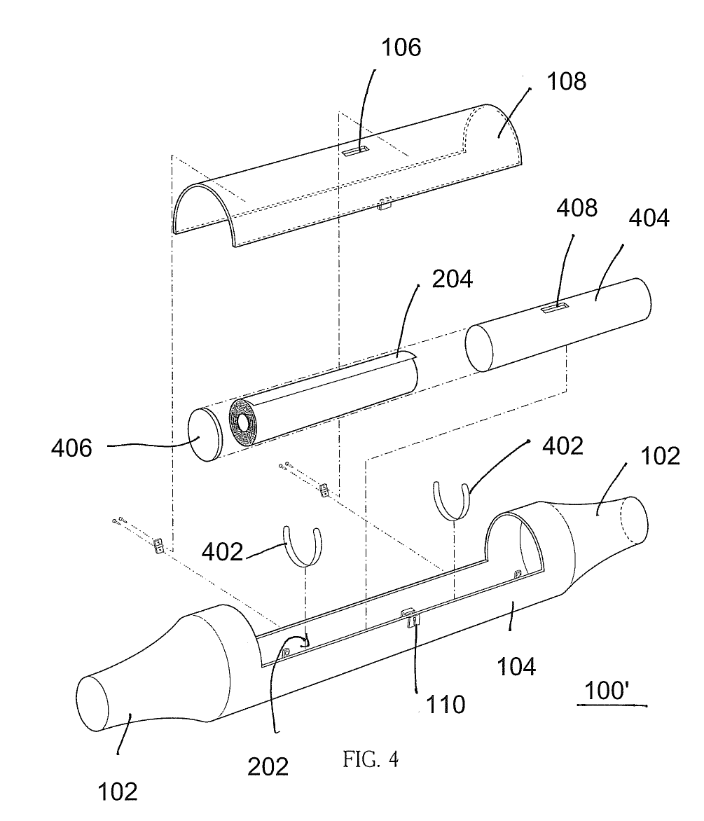

FIG. 4 is a top side exploded view of an alternative embodiment of the cart handle dispenser 100′ of the present invention. As shown in FIG. 4, canister 104 is a hollow structure with hollow interior chamber 202 to house an internal cylinder 404. In one embodiment, internal cylinder 404 is a tube like secondary-enclosure structure with one open end and a matching seal lid 406 at the open end to close internal cylinder 404. Ideally, internal cylinder 404 should be a customized canister that fits interior chamber 202 and is pre-filled with sanitary wipes 204 . End users can simply re-fill cart handle dispenser 100′ with a new internal cylinder 404 with pre-filled sanitary wipes 204. In one embodiment, slot 408 is present on the side of internal cylinder 404. As shown in FIG. 4, a roll of sanitary wipes 204 is inserted in internal cylinder 404. Sanitary wipes 204 can take the form of a roll or other designs. In one embodiment, a plurality of clips 402 are firmly affixed at the base of hollow interior 202 of canister 104. Clips 402 are to grasp internal cylinder 404 and to minimize movement of internal cylinder 404 once it is nested with slot 408 facing upward. In one embodiment, the main purpose of having secondary-enclosure internal cylinder 404 is to avoid sanitary wipes 204 from rolling and moving around inside canister portion 104 during use of the cart. As shown in FIG. 4, lid 108 is hingedly attached to canister 104 on one edge with a plurality of hinges 200 and screws 208. In one embodiment, the curvature of lid 106 should match the curvature of opening side edges 210 of canister 104 for a fitted seal. In one embodiment, lid 106 can be secured to canister 104 by locking closure 110. The main function of locking canister 104 is to avoid tempering of sanitary wipes 204. As shown in FIG. 4, dispenser slot 106 is a through hole in the shape of a rectangle or other shape that registers and/or corresponds with slot 408 . The area of dispenser slot 106 and slot 408 should be big enough for smooth passing of sanitary wipes 204.

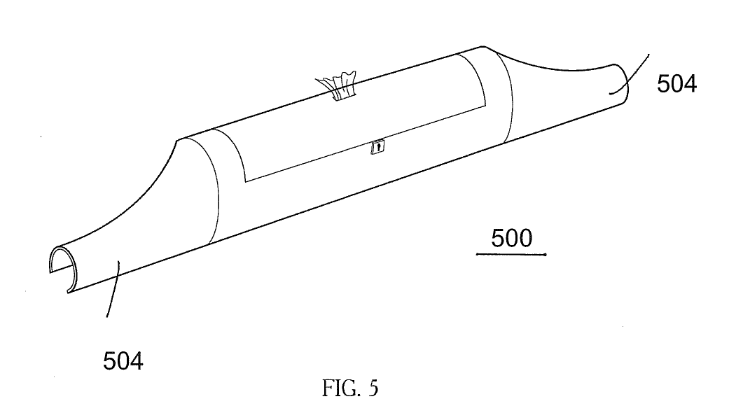

FIG. 5 is a representative top side isometric view of an alternative embodiment of the handle dispenser 500′. As shown in FIG. 5, alternative cart handle dispenser 500′ consists of two clip end portions 504 with a lengthwise opening in the shape of a slit or slot on the base, making the section of the clip end portion 504 resemble a circular “C” clip or other type of circlip. It will be understood that the lengthwise tubular portion 504 adjacent the hollow chamber 202 will clip firmly to the handle portion 302 of a cart 304. In this fashion, handle dispenser 500′ can serve to retrofit or renovate/upgrade any existing handle such as tool handles, shopping and other cart handles, staircase handles, esclator handles, etc.

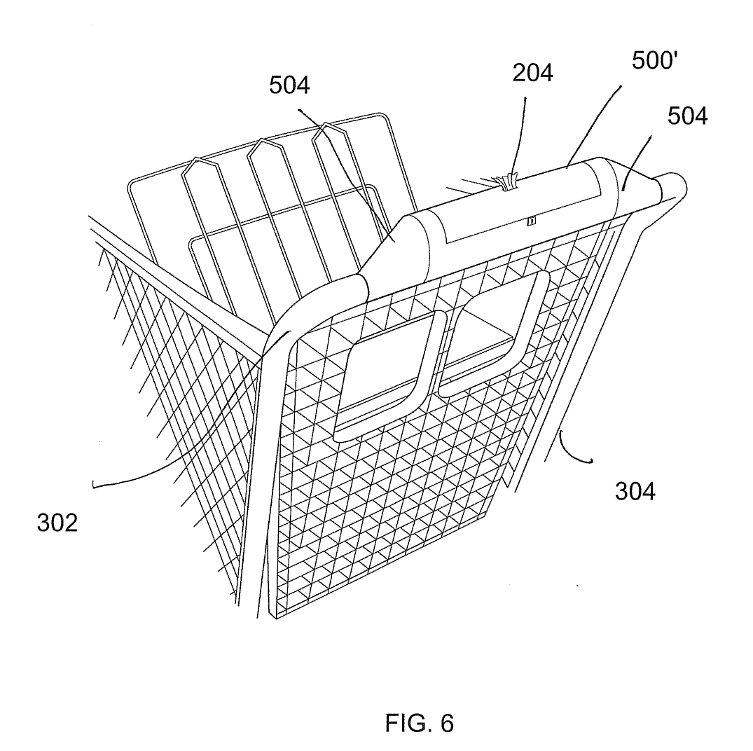

FIG. 6 shows a method of use of the handle dispenser 500′ of the present invention with a cart. As best shown in FIG. 6, the cart handle dispenser 500′ can be installed by simply clipping the elongated slit or opening clip end portions 504 onto the cart handle portion 302 of any cart 304. Attachment can be enhanced or reinforced by chemical or mechanical means. The alternate embodiment of the cart handle dispenser 500′ is particularly useful and convenient in conjunction with existing shopping carts 304. This embodiment 500′ is also part of a kit in which an existing cart 304 can be modified or retrofit to provide the enhanced sanitary wipe dispensing handle retrofit kit 500′ of the present invention.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

I claim:

1. An adapter to store and dispense sanitary wipes, the adapter having a hollow chamber for coupling integrally with the elongated handle portion of a tool.

2. The adapter of claim 1, wherein the hollow chamber is adjacent an elongated, tubular portion.

3. The adapter of claim 2, wherein the elongated, tubular portion has an elongated lengthwise opening therethrough, thereby enabling the elongated tubular portion to fit over the elongated handle portion of a tool and couple thereto.

4. The adapter of claim 2, wherein the elongated, tubular portion has an elongated lengthwise clip opening therethrough, thereby enabling the elongated tubular portion to clip over the elongated handle portion of a tool and couple thereto.

5. A cart handle having an integral wipe dispenser for storing and dispensing sanitary wipes, the cart handle comprising a hollow canister portion having two ends and an operatively-sized main chamber, two coupling end portions one each attached to each of the two ends of the canister portion, a lid portion having an operatively sized and positioned dispenser opening, the lid portion hingedly coupled to the canister portion, whereby individual sanitary wipes can be dispensed and used for sanitizing the cart handle.

6. The wipe dispenser of claim 5 in which the canister portion has a cylindrical shape.

7. The wipe dispenser of claim 5 in which the dispenser opening has a predetermined shape selected from the group consisting of rectangle, oval and circle.

8. The wipe dispenser of claim 5 has a total length in the range of approximately 20 cm to 45 cm.

9. The wipe dispenser of claim 5 in which the coupling end portions further comprises a mechanical fastening system for firmly attaching to any cart handle.

10. The wipe dispenser of claim 9 in which the mechanical fastening system is selected from the group consisting of circlips, cable tie and adhesives.

11. A cart handle having an integral wipe dispenser for storing and dispensing sanitary wipes, the cart handle comprising:
a hollow canister portion having two ends, an operatively-sized main chamber for hosting an internal housing portion and a lid portion having an operatively sized and positioned dispenser opening, the lid portion detachably coupled to the canister portion;
an internal housing portion, the internal portion having an operatively sized and positioned aperture, whereby individual sanitary wipes can pass through; and
two coupling end portions one each attached to each of the two ends of the canister portion for coupling the cart handle to a cart, whereby individual sanitary wipes can be dispensed and used for sanitizing the cart handle.

12. The wipe dispenser of claim 11 further comprising a mechanical coupling to keep the internal housing portion in place.

13. The wipe dispenser of claim 12 in which the mechanical coupling is selected from the group consisting of flexible clamps, adhesive material, hook and loop material, screws, nuts and bolts.

14. A method of storing and dispensing sanitary wipes in a shopping cart, the method comprising the following steps:
Obtaining a cart handle having an integral wipe dispenser for storing and dispensing sanitary wipes, the cart handle comprising (1) a hollow canister portion having two ends and an operatively-sized main chamber, (2) two coupling end portions one each attached to each of the two ends of the canister portion, (3) a lid portion having an operatively sized and positioned dispenser opening, the lid portion detachably coupled to the canister portion, whereby individual sanitary wipes can be dispensed and used for sanitizing the cart handle;
Selecting sanitary wipes that can fit into the main chamber;
Installing the sanitary wipes inside the canister and pulling the outer tip of sanitary wipes through the dispenser opening of the lid portion;
Closing and locking the lid portion; and
Pulling out desirable amount of sanitary wipes.
